(19) United States
(12) Patent Application Publication
(10) Pub. No.: US 2025/0173226 A1
(43) Pub. Date: May 29, 2025

(54) INFORMATION RECORDING DEVICE AND INFORMATION RECORDING METHOD

(71) Applicant: FANUC CORPORATION, Minamitsuru-gun, Yamanashi (JP)

(72) Inventor: Kazuhiro YAMATO, Yamanashi (JP)

(21) Appl. No.: 18/843,792

(22) PCT Filed: May 10, 2022
(86) PCT No.: PCT/JP2022/019865

§ 371 Date: Sep. 4, 2024

(51) Int. Cl. G06F 11/14

(52) U.S. Cl. CPC G06F 11/1456; G06F 11/1438

(57) ABSTRACT

An information recording device (2) comprising a data storage (221), an information recording unit (211) for recording information from a data storage apparatus (1A), and a primary backup storage (222) in which information recorded to the data storage is backed up. In order to shorten the time at which data updates, etc., in the data storage are halted when backing up the data storage that stores information from the apparatus, the backup is carried out in the primary backup storage while data updates are kept halted by the information recording unit, and the information recording unit restarts writing to the data storage when the backup in the primary backup storage is complete and deletes the information recorded to the primary backup storage when the backup to the backup storage (3) of information recorded to the primary backup storage is complete.

### TECHNICAL FIELD

The present invention relates to an information recording device and an information recording method for creating a primary backup in a high-speed storage device and subsequently making a copy of the primary backup in a backup storage.

### BACKGROUND ART

Conventionally, a technique of creating a backup in preparation for breakdown of a storage device has been employed in information recording in, for example, a database. It should be noted that if writing (update, addition, or the like) to a data file in a data storage occurs while the data file is being backed up, the coherency of a backup file may be lost (the backup file may become corrupted). FIG. 5A is a diagram showing the outline of a case where writing to a data file in a data storage is performed while the data file is being backed up. As shown in FIG. 5A, while a data file V1 is being backed up (copied), if data is written and the data file V1 changes into a data file V2 accordingly, the state of the data file V1 is copied up to the middle of the backup, and the state of the data file V2 is copied thereafter. As a result, a data file copy which is neither V1 nor V2 is made. For this reason, in a case where the data file in the data storage is backed up (copied), data update, data addition, or the like needs to be stopped for the data file which is being backed up until completion of the backup. FIG. 5B is a diagram showing the outline of a case where writing to a data file in a data storage is stopped while the data file is being backed up. As shown in FIG. 5B, writing to the data file is performed after completion of the backup of the data file so that backup file corruption during the backup can be reduced. Patent Document 1 describes, as the related art, that data update, data addition, etc. are stopped for a database which is being backed up.

### CITATION LIST

### Patent Document

Patent Document 1: Japanese Unexamined Patent Application, Publication No. 2001-306407

### DISCLOSURE OF THE INVENTION

### Problems to be Solved by the Invention

In a case where it takes a long time to back up a data file in a data storage, data cannot be updated, added or the like during the backup, which may lead to an influence making, for example, a data writing requester unable to execute a subsequent operation. Particularly, in a case where a data file backup destination is a remote storage device (network attached storage (NAS)) connected via a network or a low-speed storage device, the above-described problem becomes prominent. For this reason, when backing up a data file, it has been demanded to shorten the time for which a data update or the like in a data file is prohibited in order to shorten the time for which data file update, data addition, or the like is stopped and to reduce the influence making, for example, a data writing requester unable to execute a subsequent operation.

The present invention has been made in view of the above-described problems, and an object thereof is to provide an information recording device capable of shortening a data file backup time in backup of a data file in a data storage to shorten the time for which, data file update, data addition, or the like is stopped and to reduce the influence making, for example, a data writing requester unable to execute a subsequent operation.

### Means for Solving the Problems

One aspect of the information recording device of the present disclosure is an information recording device communicably connected to a backup storage, the information recording device including a data storage that stores information from a device, a primary backup storage that stores a backup of the information recoded in the data storage,
an information recording unit that records the information in the data storage in response to a writing request,
a primary backup creation unit that when receiving an instruction for starting backup of the information recorded in the data storage, stops the information recording unit or puts the writing request on hold, while stopping the information recording unit or putting the writing request on hold, backs up the information recorded in the data storage to the primary backup storage, and when completing the backup, restarts the information recording unit or resumes writing to the data storage, and
a backup copy unit that backs up the information recorded in the primary backup storage to the backup storage. The backup copy unit further deletes the information recoded in the primary backup storage after completion of the backup of the information recorded in the primary backup storage to the backup storage.

One aspect of the information recording method of the present disclosure is an information recording method by an information recording device communicably connected to a backup storage and including a data storage that stores information from a device and a primary backup storage that stores a backup of the information recoded in the data storage, the method including
an information recording step of recording the information in the data storage in response to a writing request,
a stop instruction step of when receiving an instruction for starting backup of the information recorded in the data storage, stopping the information recording step or putting the writing request on hold,
a primary backup creation step of while stopping the information recording step or putting the writing request on hold in the stop instruction step, backing up the information recorded in the data storage to the primary backup storage,
a restart instruction step of when completing the backup in the primary backup creation step, restarting the information recording step or resuming writing to the data storage, and
a backup copy step of backing up the information recorded in the primary backup storage to the backup storage. The backup copy step further includes a step of deleting the information recoded in the primary backup storage after completion of the backup of the information recorded in the primary backup storage to the backup storage.

### Effects of the Invention

According to one aspect, the data file backup time is shortened in the backup of the data file in the data storage so that the time for which data file update, data addition, or the like is stopped can be shortened and, the influence making, for example, the data writing requester unable to execute a subsequent operation can be reduced.

### BRIEF DESCRIPTION OF THE DRAWINGS

FIG. 1 is a schematic diagram showing a system configuration of a backup system according to one embodiment;

FIG. 2 is a conceptual diagram showing one form when backup data is created in an information recording device according to one embodiment;

FIG. 3 is a conceptual diagram showing one form when backup data is created in a configuration in which a data storage of the information recording device according to one embodiment includes a plurality of data files;

FIG. 4 is a flowchart showing operation of the information recording device according to one embodiment;

FIG. 5A is a diagram showing the outline of a case where writing to a data file in a data storage is performed while the data file is being backed up; and

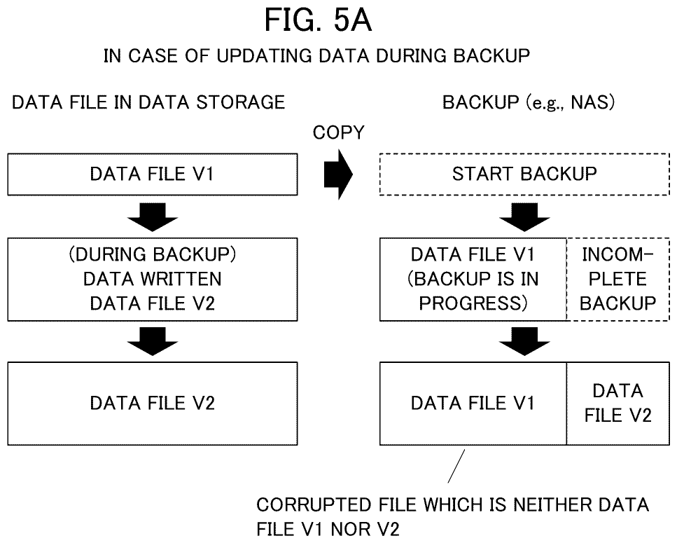

FIG. 5B is a diagram showing the outline of a case where writing to a data file in a data storage is stopped while the data file is being backed up.

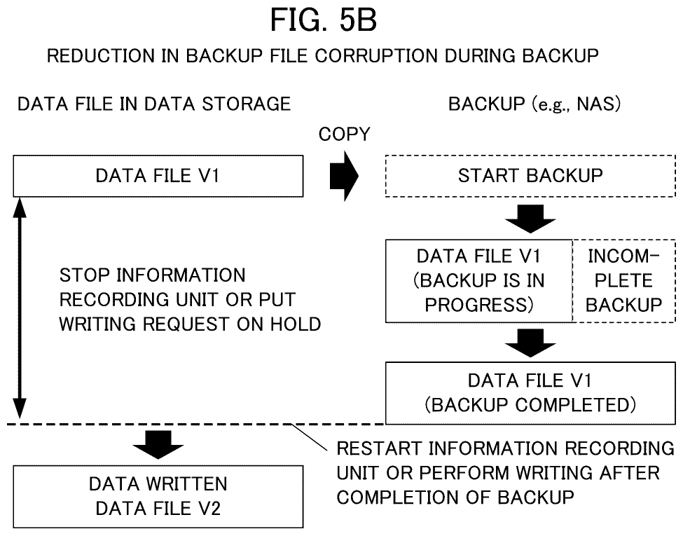

### PREFERRED MODE FOR CARRYING OUT THE INVENTION

Hereinafter, an embodiment of the present invention will be described with reference to the drawings.

### [Configuration]

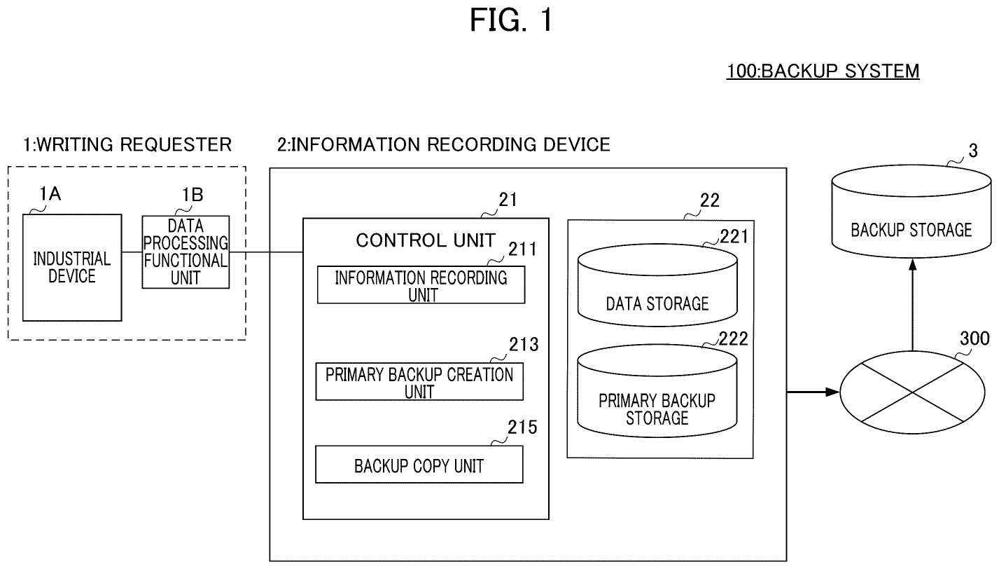

FIG. 1 is a schematic diagram showing a system configuration of a backup system 100 according to one embodiment of the present invention. As shown in FIG. 1, the backup system 100 includes a writing requester 1, an information recording device 2, and a backup storage 3, and the writing requester 1 and the information recording device 2 are communicable with each other. The writing requester 1 and the information recording device 2 may be communicably connected to each other via a network 300 such as a local area network (LAN) or the Internet. Alternatively, these components may be directly connected to each other via a not-shown connection interface. Similarly, the information recording device 2 and the backup storage 3 may be communicably connected to each other via the network 300 such as a local area network (LAN) or the Internet.

In the present embodiment, for example, a configuration including an industrial device 1A such as a machine tool or an industrial robot and a data processing functional unit 1B that communicates information from the industrial device 1A directly to the information recording device 2 to request the information recording device 2 to write the information will be described as an example of the writing requester 1. That is, the data processing functional unit 1B executes the function of an input/output interface for the information recording device 2 in the writing requester 1. Note that the industrial device 1A may include the data processing functional unit 1B. The industrial device is well-known by those skilled in the art, and therefore, detailed description thereof will be omitted. For example, as a database system, the data processing functional unit 1B may be provided between the industrial device 1A and the information recording device 2 independently of the industrial device 1A and the information recording device 2. Alternatively, instead of the industrial device 1A, an arbitrary device or an information processing device or an information processing system having a server function may be provided. The data processing functional unit 1B may request the information recording device 2 to write information from the information processing device or the information processing system. In the present embodiment, information on each of three steps including, for example, a drilling step X, an assembly step Y, and an inspection step Z will be described later as an example of the information from the industrial device 1A. In this case, examples of the information from the industrial device 1A include information on the drilling step X, such as a workpiece ID, a machining time, a program number, a tool model number, and a worker name, information on the assembly step Y, such as a component serial number, a module number, and a worker, and information on the inspection step Z, such as a module serial number, an inspection device control number, and a room temperature.

The information recording device 2 will be described. As shown in FIG. 1, the information recording device 2 includes a control unit 21 and a storage unit 22. The control unit 21 reads a program for executing a function unique to the invention of the present application, for example, from the storage unit 22, and executes the program using data stored in a main storage device (not shown), such as a RAM, for storing data temporarily required for executing the program to implement the functions of an information recording unit 211, a primary backup creation unit 213, and a backup copy unit 215 as shown in FIG. 1. These functional units will be described later.

As shown in FIG. 1, the storage unit 22 includes a data storage 221 and a primary backup storage 222.

The data storage 221 is a recording medium, such as a hard disk drive, that stores a data file including the information from the industrial device 1A, which is recorded in response to the writing request. The data storage 221 may be separately managed (partitioned) as a plurality of storage areas. With this configuration, for example, a plurality of data files can be set in the data storage, and a primary backup and a backup can be made independently for each data file. Thus, a time required for the primary backup of each data file can be shortened, and a time for which the information recording unit 211 is stopped or the writing request is on hold in response to the request for writing to the data file can be shortened. Details will be described later.

The primary backup storage 222 is a high-speed storage device, and examples thereof include an all-flash storage. With this configuration, the data file can be primarily backed up to the primary backup storage 222 at a higher speed as compared to a low-speed device such as a NAS, as described later. Thus, the time for which the information recording unit 211 is stopped or the writing request is on hold can be shortened.

A case where the backup storage 3 is included, for example, in a file server (not shown) and is formed as a so-called network attached storage (NAS) will be described as an example, but the present invention is not limited thereto. For example, a low-speed storage device communicably connected to the information recording device 2 may be provided as the backup storage 3.

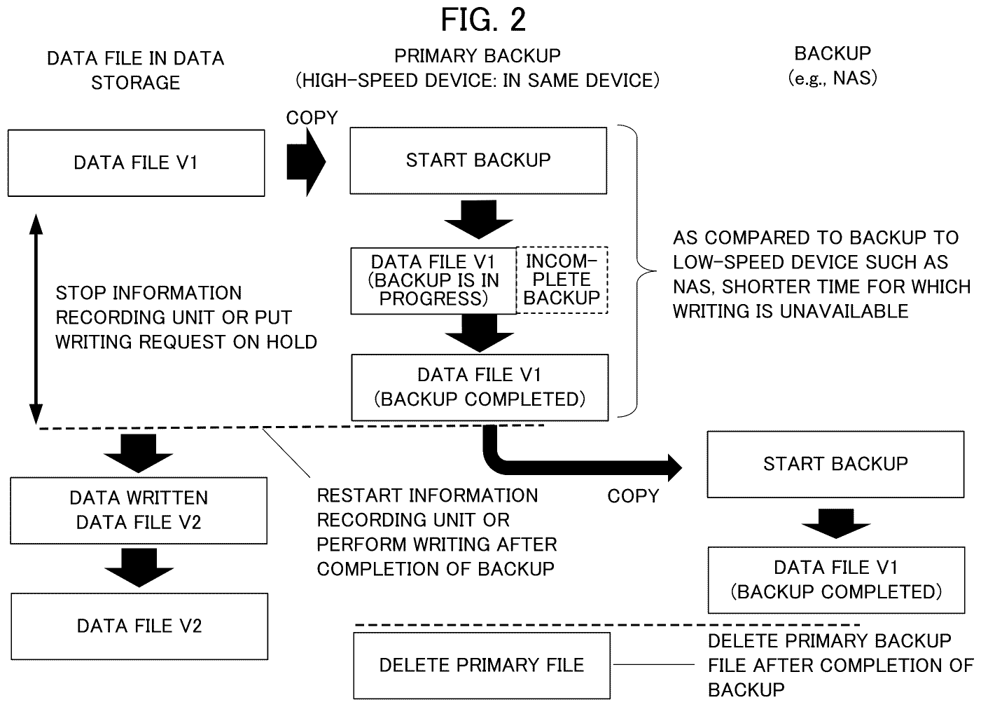

The outline of the processing of the information recording device 2 will be described before the functional units in the information recording device 2 are described. FIG. 2 is a conceptual diagram showing one form when backup data is created. Referring to FIG. 2, in a case where the data file in the data storage 221 is backed up, the data file is first primarily backed up to the primary backup storage 222 which is the high-speed device. During execution of the primary backup, writing to the data file is stopped or on hold, and after completion of the backup of the data file, is resumed. Since the primary backup storage 222 is the high-speed device, a time for which writing to the data file is unavailable can be significantly decreased as compared to a time for which writing to the data file is stopped or on hold during execution of the backup by the conventional low-speed device such as a NAS. Next, a copy of the primary backup data in the primary backup storage 222 is made in the backup storage 3, such as a NAS, communicably connected to the information recording device 2 so that the backup can be made to the backup storage 3, such as a NAS, as usual. Note that writing to the data file is neither stopped nor on hold for a time for which the copy of the data in the primary backup storage 222 is made in the backup storage 3, and therefore, the object of the invention of the present application can be achieved, i.e., a time for which, data file update, data addition or the like is stopped can be shortened and the influence making, for example, the industrial device 1A unable to execute a subsequent operation can be reduced, Note that after completion of the backup to the backup storage 3, the primary backup data of the data file is deleted from the primary backup storage 222 so that the capacity of the primary backup storage 222 can be recovered. The outline of the backup processing of the information recording device 2 has been described above. Next, the functional units in the information recording device 2 will be described. As described above, the control unit 21 includes the information recording unit 211, the primary backup creation unit 213, and the backup copy unit 215.

In response to the writing request, the information recording unit 211 records the information in the data file (not shown) in the data storage 221, which is targeted for the writing request. In a case where the plurality of data files is set in the data storage 221, the information recording unit 211 can independently record the information in each data file which is a writing destination. Specifically, the information writing request specifies a data file name which is an information recording destination, and the information recording unit 211 records the information based on the writing request for the specified data file. The information recording unit 211 may independently perform the writing processing in parallel in response to writing requests for different data files. In a case where the plurality of data files is set in the data storage 221, when, for example, a primary data backup of a certain data file X (not shown) in the data storage 221 is created, the primary backup creation unit 213 instructs the information recording unit 211 to stop writing the information to the data file X or to put the writing request on hold as described later. In response, the information recording unit 211 stops writing the information to the data file X, or puts such writing on hold, for example. Note that in response to a request for writing the information to a data file other than the data file X, the information recording unit 211 can record the information to such a data file which is a writing destination.

When receiving an instruction for starting the backup of the information recorded in the data storage 221, the primary backup creation unit 213 stops the information recording unit 211 or puts the writing request on hold. Note that as described above, in a case where the plurality of data files is set in the data storage 221, the backup start instruction specifies a data file targeted for the backup from the plurality of data files set in the data storage 221. The primary backup creation unit 213 causes the information recording unit 211 to stop writing the information to the data file targeted for the backup or to put the writing request on hold. The information recording unit 211 stops writing the information to the data file targeted for the backup or puts the writing request on hold, but in response to a request for writing the information to a data file other than the data file targeted for the backup, can record the information based on the writing request.

The primary backup creation unit 213 causes the information recording unit 211 to stop writing the information to the data file targeted for the backup or to put the writing request on hold, and thereafter, backs up the data file targeted for the backup, which is recorded in the data storage 221, to the primary backup storage 222. As described above, in a case where the plurality of data files is set in the data storage 221, the primary backup is independently made only for the data file targeted for the backup among the plurality of data files set in the data storage 221, and the primary backup data of the data file is created in the primary backup storage 222. The plurality of data files is set in the data storage 221 so that the information recording device 2 can further shorten the time for which data update, data addition, or the like is stopped for each of the plurality of data files in the data storage 221 and can further reduce the influence making, for example, the industrial device 1A unable to execute a subsequent operation. As described above, for the data file which is not targeted for the backup, the information recording unit 211 can record the information based on the writing request without putting the writing request on hold. Note that the primary backup creation unit 213 may perform primary backup processing of independently making, in parallel, a primary backup of a certain data file 1 (not shown) and a primary backup of another data file 2 (not shown) different from the data file 1.

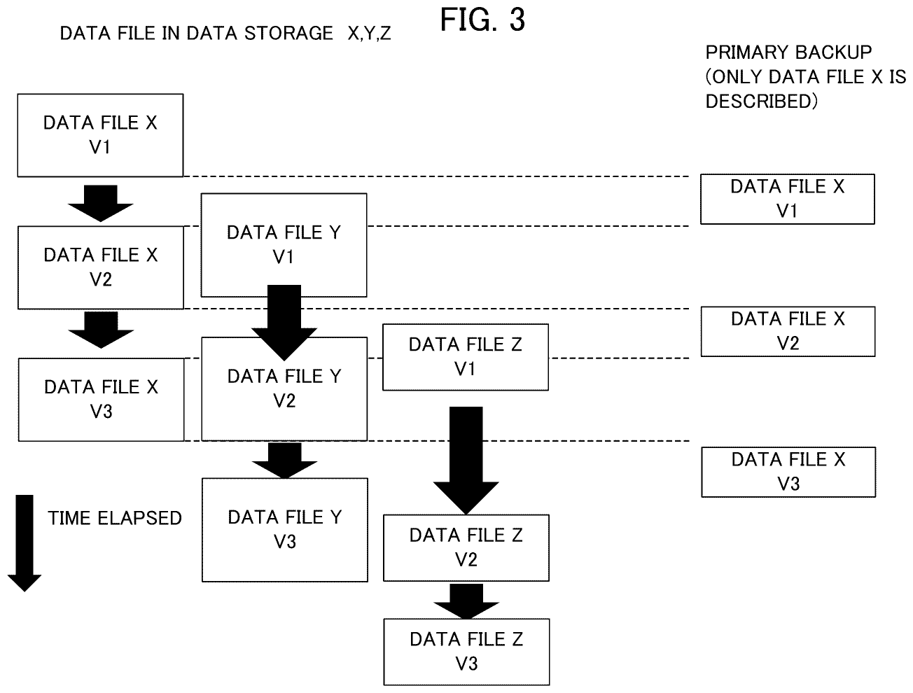

The outline of the processing of the information recording device 2 in a case where the plurality of data files is set in the data storage 221 and the backup is independently created for each data file will be described, FIG. 3 is a conceptual diagram showing one form when the backup data is created in the configuration in which the data storage of the information recording device includes the plurality of data files. As shown in FIG. 3, three data files X, Y, Z are set in the data storage 221, and the writing request can be independently made for each of the data files X, Y, Z. Here, the form when the data file X is primarily backed up will be described. Referring to FIG. 3, the information recording device 2 writes the information to the data file X in predetermined cycles, and in between these cycles, creates the primary backup data of the data file X in the primary backup storage 222. Then, during creation of the primary backup data of the data file X, writing to the data file X is stopped. Meanwhile, writing to the data file Y and writing to the data file Z are available as shown in FIG. 3. In a case where the plurality of data files is set in the data storage 221 as described above, the information recording unit 211 can record the information based on the writing request for the data file other than the data file targeted for the backup.

The form shown in FIG. 3 is applicable to, for example, a case where the device 1A is the industrial device as described above and the information recording device 2 records, for each of the three manufacturing steps including the drilling step X, the assembly step Y, and the inspection step Z, the information on each manufacturing step in the three data files X, Y, Z set in the data storage 221 as described above. In this case, the information recording device 2 records, for example, the workpiece ID, the machining time, the program number, the tool model number, and the worker name in the drilling step X in the data file X, records, for example, the component serial number, the module number, and the worker in the assembly step Y in the data file Y, and records, for example, the module serial number, the inspection device control number, and the room temperature in the inspection step Z in the data file Z. In this manner, an effective processing cycle can be achieved at a factory. Thus, the cycles of each manufacturing step are set and the required capacity of the primary backup storage 222 is customized so that the information recorded in each data file of the data storage 221 recording the information on each manufacturing step can be backed up to the primary backup storage 222 in between the cycles of each manufacturing step. This can avoid a situation where the information writing request is on hold in the cycles of each manufacturing step.

After completion of the primary backup of the data file to the primary backup storage 222, the primary backup creation unit 213 restarts the information recording unit 211 or causes the information recording unit 211 to resume information recording to the data storage 221 based on the writing request. Note that as described above, in a case where the plurality of data files is set in the data storage 221, the primary backup creation unit 213 completes the primary backup of the data file targeted for the backup to the primary backup storage 222 among the plurality of data files set in the data storage 221, and then, causes the information recording unit 211 to restart writing the information to the data file or to resume information recording to the data file based on the writing request.

The backup copy unit 215 backs up, to the backup storage 3, the primary backup data recorded in the primary backup storage 222 by the primary backup creation unit 213, and after completion of the backup of the primary backup data recorded in the primary backup storage 222 to the backup storage 3, deletes the information recorded in the primary backup storage 222. Note that in a case where the plurality of data files is set in the data storage 221, the backup copy unit 215 backs up, to the backup storage 3, the information on the data file primarily backed up to the primary backup storage 222 among the plurality of data files set in the data storage 221, and after completion of the backup of the data file recorded in the primary backup storage 222 to the backup storage 3, deletes the primary backup data of the data file recorded in the primary backup storage 222. In this manner, the capacity of the primary backup storage 222 can be recovered.

Specifically, the backup storage 3 records the backup data of all the data files in chronological order. On the other hand, the primary backup storage 222 has a kind of temporary buffer area, and an area, where the primary backup data is recorded, can be recovered after the copy of the primary backup data has been made in the backup storage 3. Note that the backup copy unit 215 may independently perform, in parallel, backup processing of backing up primary backup data of a certain data file 1 (not shown) to the backup storage 3 and backup processing of backing up primary backup data of another data file 2 (not shown) different from the data file 1 to the backup storage 3. The functional units in the information recording device 2 have been described above.

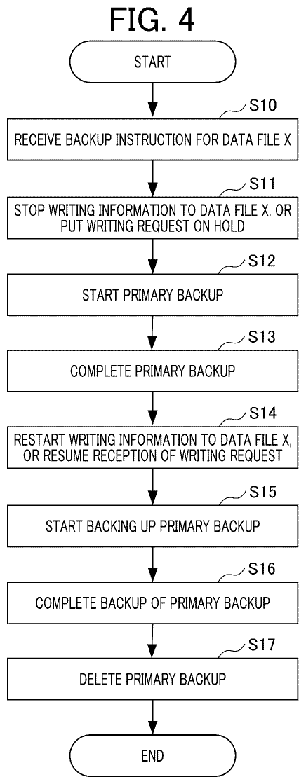

FIG. 4 is a flowchart showing operation of the information recording device 2. Here, a processing flow when information recorded in a data file (referred to as a “data file X”) (not shown) set in the data storage 221 is backed up to the backup storage 3 will be described. Note that in a case where the plurality of data files is set in the data storage 221 and is separately managed, the information recording device 2 can back up each data file to the backup storage 3 as described above.

Referring to FIG. 4, in Step S10, the primary backup creation unit 213 receives a backup instruction for the data file X.

In Step S11, the information recording unit 211 stops writing the information to the data file X, or puts the writing request on hold.

In Step S12, the primary backup creation unit 213 starts backing up the information recorded in the data file X to the primary backup storage 222.

In Step S13, the primary backup creation unit 213 completes the backup of the information recorded in the data file X to the primary backup storage 222.

In Step S14, the primary backup creation unit 213 restarts the information recording unit 211, or causes the information recording unit 211 to resume data file information recording to the data file X based on the writing request.

In Step S15, the backup copy unit 215 starts backing up the primary backup data of the data file X recorded in the primary backup storage 222 to the backup storage 3.

In Step 16, the backup copy unit 215 completes the backup of the primary backup data of the data file X recorded in the primary backup storage 222 to the backup storage 3.

In Step S17, the backup copy unit 215 deletes the primary backup data of the data file X recorded in the primary backup storage 222. The processing flow related to the backup of the data file X in the information recording device 2 has been described above.

By the above-described processing, the information recording device 2 shortens the data file backup time in the backup of the data file in the data storage 221 so that the time for which data file update, data addition, or the like is stopped can be shortened and the influence making, for example, the industrial device 1A unable to execute a subsequent operation can be reduced.

All or some of the functions of the backup system 100 of the above-described embodiment may be implemented by hardware, software, or a combination thereof. Here, implementation by the software means implementation by reading and execution of a program by a processor. In the case of the hardware, some or all of the functions of the backup system 100 can be implemented by an integrated circuit (IC) such as an application specific integrated circuit (ASIC), a gate array, a field programmable gate array (FPGA), or a complex programmable logic device (CPLD).

In a case where all or some of the functions of the backup system 100 are implemented by the software, a computer including a storage unit, such as a hard disk or a ROM, that stores programs describing all or some of operations of the backup system 100, a DRAM that stores data required for arithmetic processing, a CPU, and a bus that connects these components implements the functions in such a manner that the information required for the arithmetic processing is stored in the DRAM and the CPU operates the programs.

These programs can be stored using various types of Computer readable media and be supplied to the computer. The computer readable media include various types of tangible storage media. Examples of the computer readable medium include magnetic recording media (e.g., a flexible disk, a magnetic tape, and a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a random access memory (RAM)). These programs may be distributed in such a manner that the programs are downloaded in a user's computer via a network.

The embodiment of the present invention has been described above in detail, but the above-described embodiment is merely a specific example of implementation of the present invention. The technical scope of the present invention is not limited to the above-described embodiment. Various changes can be made to the present invention without departing from the gist of the present invention, and are also included in the technical scope of the present invention.

### [Modification 1]

In the above-described embodiment, the remote storage device (network attached storage (NAS)) connected via the network has been described as an example of the backup storage 3, but the present invention is not limited thereto. For example, the backup storage 3 may be connected onto a LAN. Alternatively, the backup storage 3 may be directly connected to the information recording device 2 via, for example, a communication line.

### [Modification 2]

In the above-described embodiment, the configuration in which the primary backup storage 222 is included in the information recording device 2 has been described as an example, but the present invention is not limited thereto. The primary backup storage 222 may be connected as an external storage device for the information recording device 2.

### [Modification 3]

In the above-described embodiment, the primary backup storage 222 may have, as a file system, a copy-on-write function (function of making a copy of only management information, which includes, for example, a data pointer of a file and making a copy of only a change-related portion upon actual data change). With this configuration, the time required for the primary backup can be further shortened,

### [Modification 4]

In the above-described embodiment, the form in which the information recording device 2 receives the writing request transmitted from the writing requester 1 has been described as an example, but examples of the form in which the writing requester 1 transmits the writing request include a form in which the writing requester 1 mainly transmits the writing request to the information recording device 2 in a case where there is the writing request and a form in which the information recording device 2 makes an inquiry to the writing requester 1 about whether or not there is the writing request at, for example, certain intervals (e.g., polling) and the writing requester 1 transmits the writing request to the information recording device 2 in response to the inquiry from the information recording device 2 in a case where there is the writing request. In any form, the information recording device 2 receives (acquires) the writing request from the writing requester 1. Note that in the latter form, the information recording device 2 may include, for polling for a plurality of writing requesters 1 set in advance, a functional unit (not shown) that makes an inquiry to the writing requester 1 about whether or not there is the writing request at, for example, certain intervals (e.g., polling). The writing requester 1 may also include a functional unit (not shown) that transmits, for example, the writing request in response to the inquiry from the information recording device 2. Moreover, in the latter form, the flowchart of operation of the information recording device 2 may additionally include a step (not shown) of making an inquiry to the writing requester 1 at, for example, certain intervals and a step of receiving the writing request in a case where there is the writing request and receiving the backup instruction in a case where there is the backup instruction.

In other words, the information recording device and the information recording method of the present disclosure may include various embodiments having the following configurations.

(1) The information recording device 2 of the present disclosure is an information recording device 2 communicably connected to a backup storage 3, the information recording device 2 including a data storage 221 that stores information from a device 1A,
a primary backup storage 222 that stores a backup of the information recoded in the data storage 221,
an information recording unit 211 that records the information in the data storage 221 in response to a writing request,
a primary backup creation unit 213 that when receiving an instruction for starting backup of the information recorded in the data storage 221, stops the information recording unit 211 or puts the writing request on hold, while stopping the information recording unit 211 or putting the writing request on hold, backs up the information recorded in the data storage 221 to the primary backup storage 222, and when completing the backup, restarts the information recording unit 211 or resumes writing to the data storage 221, and
a backup copy unit 215 that backs up the information recorded in the primary backup storage 222 to the backup storage 3. The backup copy unit 215 further deletes the information recoded in the primary backup storage 222 after completion of the backup of the information recorded in the primary backup storage 222 to the backup storage 3. According to the information recording device 2, a backup time for the data storage 221 is shortened in the backup of the data storage 221 so that a time for which, update, data addition, or the like in the data storage 221 is stopped can be shortened and, the influence making, for example, a data writing requester unable to execute a subsequent operation can be reduced.

(2) In the information recording device 2 according to (1), the data storage 221 may be set such that a plurality of storage areas is separately managed, the information recording unit 211 may record the information in each of the plurality of storage areas in response to the writing request, and the primary backup creation unit 213 may back up the information recorded in each of the plurality of storage areas of the data storage 221. The information recording device 2 backs up the information recorded in each of the plurality of storage areas to the primary backup storage 222 so that a time required for the backup can be shortened, a time for which data update, data addition, or the like in each of the plurality of storage areas of the data storage 221 is stopped can be shortened, and, the influence making, for example, the device 1A unable to execute a subsequent operation can be reduced.

(3) In the information recording device 2 according to (1) or (2), the device 1A may be an industrial device. With this configuration, the information recording device 2 can provide effects similar to those of (1) or (2).

(4) In the information recording device 2 according to (3), the information recording unit 211 may associate a manufacturing step using the industrial device 1A with each of the plurality of storage areas of the data storage 221, and record the information in the storage area corresponding to each manufacturing step in response to a request for writing information related to the manufacturing step. The primary backup creation unit 212 may back up the information recorded in the storage area corresponding to each manufacturing step to the primary backup storage 222 in between manufacturing step cycles in which the information recording unit 211 records the information in response to the writing request. The cycles are set or the primary backup storage 222 is selected so that the information recorded in each of the plurality of areas of the data storage 221 recording the information related to each manufacturing step can be backed up to the primary backup storage 222 in between the manufacturing step cycles. Thus, a situation where the information writing request is on hold in the manufacturing step cycles can be avoided.

(5) In the information recording device 2 according to (1) or (2), the primary backup creation unit 213 may record, in the primary backup storage 222, the information recorded in primary backup creation based on a copy-on-write function. A time required for primary backup creation is further shortened so that the time for which update, data addition, or the like in the data storage 221 is stopped can be further shortened and the influence making, for example, the data writing requester unable to execute a subsequent operation can be further reduced.

(6) The information recording method of the present disclosure is an information recording method by an information recording device 2 communicably connected to a backup storage 3 and including a data storage 221 that stores information from a device 1A and a primary backup storage 222 that stores a backup of the information recoded in the data storage 221, the method including
an information recording step of recording the information in the data storage 221 in response to a writing request,
a stop instruction step of when receiving an instruction for starting backup of the information recorded in the data storage 221, stopping the information recording step or putting the writing request on hold,
a primary backup creation step of while stopping the information recording step or putting the writing request on hold in the stop instruction step, backing up the information recorded in the data storage 221 to the primary backup storage 222,
a restart instruction step of when completing the backup in the primary backup creation step, restarting the information recording step or resuming writing to the data storage 221, and
a backup copy step of backing up the information recorded in the primary backup storage 222 to the backup storage 3. The backup copy step further includes a step of deleting the information recoded in the primary backup storage 222 after completion of the backup of the information recorded in the primary backup storage 222 to the backup storage 3. According to the information recording method, effects similar to those of (1) can be provided.

### EXPLANATION OF REFERENCE NUMERALS

100 Backup System
1 Writing Requester
1A Industrial Device
1B Data Processing Functional Unit
2 Information Recording Device
21 Control Unit
211 Information Recording Unit
213 Primary Backup Creation Unit
215 Backup Copy Unit
22 Storage Unit
221 Data Storage
222 Primary Backup Storage
3 Backup Storage
300 Network

1. An information recording device communicably connected to a backup storage, comprising:
a data storage that stores information from a device;
a primary backup storage that stores a backup of the information recoded in the data storage;
an information recording unit that records the information in the data storage in response to a writing request;
a primary backup creation unit that when receiving an instruction for starting backup of the information recorded in the data storage, stops the information recording unit or puts the writing request on hold,
while stopping the information recording unit or putting the writing request on hold, backs up the information recorded in the data storage to the primary backup storage, and
when completing the backup, restarts the information recording unit or resumes writing to the data storage; and
a backup copy unit that backs up the information recorded in the primary backup storage to the backup storage,
wherein the backup copy unit further
deletes the information recoded in the primary backup storage after completion of the backup of the information recorded in the primary backup storage to the backup storage.

2. The information recording device according to claim 1, wherein
the data storage
is set such that a plurality of storage areas is separately managed,
the information recording unit
records the information in each of the plurality of storage areas in response to the writing request, and
the primary backup creation unit
backs up the information recorded in each of the plurality of storage areas of the data storage.

3. The information recording device according to claim 1, wherein the device is an industrial device.

4. The information recording device according to claim 3, wherein
the information recording unit associates a manufacturing step using the industrial device with each of the plurality of storage areas of the data storage, and records the information in the storage area corresponding to each manufacturing step in response to a request for writing information related to the manufacturing step, and
the primary backup creation unit backs up the information recorded in the storage area corresponding to each manufacturing step to the primary backup storage in between manufacturing step cycles in which the information recording unit records the information in response to the writing request.

5. The information recording device according to claim 1, wherein
the primary backup creation unit
records, in the primary backup storage, the information recorded in primary backup creation based on a copy-on-write function.

6. An information recording method by an information recording device communicably connected to a backup storage and including a data storage that stores information from a device and a primary backup storage that stores a backup of the information recoded in the data storage, comprising:
an information recording step of recording the information in the data storage in response to a writing request;
a stop instruction step of when receiving an instruction for starting backup of the information recorded in the data storage, stopping the information recording step or putting the writing request on hold;
a primary backup creation step of while stopping the information recording step or putting the writing request on hold in the stop instruction step, backing up the information recorded in the data storage to the primary backup storage;
a restart instruction step of when completing the backup in the primary backup creation step, restarting the information recording step or resuming writing to the data storage; and
a backup copy step of backing up the information recorded in the primary backup storage to the backup storage,
wherein the backup copy step further includes
a step of deleting the information recoded in the primary backup storage after completion of the backup of the information recorded in the primary backup storage to the backup storage.
